(19) United States
(12) Patent Application Publication
(10) Pub. No.: US 2011/0016146 A1
(43) Pub. Date: Jan. 20, 2011

(54) Method for supporting the formation of car pools

(75) Inventor: Thomas Teufel, Balgheim (DE)

Correspondence Address: COLLARD & ROE, P.C., 1077 NORTHERN BOULEVARD, ROSLYN, NY, 11576, US

(73) Assignee: PAADE GmbH, Balgheim (DE)

(21) Appl. No.: 12/802,987

(22) Filed: Jun. 17, 2010

(30) Foreign Application Priority Data
Jul. 14, 2009 (DE) 10 2009 026 171.0
Mar. 3, 2010 (EP) 10002143.5

(51) Int. Cl. G06F 17/30; G01C 21/36

(52) U.S. Cl. 707/769; 707/E17.014

(57) ABSTRACT

To allow drivers of different vehicles to make contact with one another, a user terminal is provided in the vehicle, which accesses a server having a connected database. By way of this database, contact with another user who is also entered in the database, might be using the same travel route, and is therefore noticed by the user, can be established by inputting a vehicle license plate as a user ID. When a travel destination is input into a navigation device, the travel route calculated is entered in the database, and the server automatically undertakes a comparison with travel routes of other users who are contained in the database, and establishes contact between the users who have correlating user data sets.

### CROSS REFERENCE TO RELATED APPLICATIONS

Applicant claims priority under 35 U.S.C. §119 of German Application No. 10 2009 026 171.0 filed Jul. 14, 2009 and European Application No. 10002143.5 filed Mar. 3, 2010.

### BACKGROUND OF THE INVENTION

1. Field of the Invention

The present invention relates to a method for supporting the formation of car pools. More particularly, the present invention relates to a method in which a user terminal is data-connected with a server that comprises a database, and the database contains a user data set assigned to the user terminal. The server searches for correlating second user data sets within the database upon a query from the user terminal, and, in the event of success, transmits a public part of these second user data sets to the user terminal.

2. The Prior Art

A method of this type is known from U.S. patent application 2006/0059229 A1. Such a system is based on a central server, with which a data exchange can be carried out, proceeding from a user terminal, particularly by way of wireless communication. First, it is necessary to register with the server service for this purpose, whereby a user data set is drawn up, which is assigned to the user terminal, in each instance. The aforementioned method then provides that an individual ID, in other words the motor vehicle license plate of the user, for example, is assigned to a user data set, and that communication, by way of the server, is produced by a user by entering a motor vehicle license plate seen on the road into the user terminal. The server receives the message, using the motor vehicle license plate as an ID, and passes it on to the user terminal to which the ID in question is assigned. Among other things, such a system is used also for initiation of contacts for forming car pools.

The system of the German utility model DE 298 22 488 U1 also functions in a similar manner. Here, a direct voice connection between the user terminals is mediated, instead of allowing the communication in question to run by way of the server. For the remainder, however, the method of procedure is similar.

For extremely varied reasons, car pools represent an alternative to public means of transportation that is increasingly gaining in popularity. In contrast to driving alone in one's own vehicle, even if a car pool consists of only two persons, the bottom line is that the costs for a vehicle are saved, gasoline costs are cut in half, and, at the same time, the environment is protected and the burden on roads is relieved.

Thus, car pool exchanges have already been known on the Internet for quite some time, where the users, in each instance, can register and file the travel routes that they travel. Then, other users can carry out a search for specific travel routes on these data sets, find other travelers having the same route and, if necessary, also at the same time, and contact them with the goal of forming a car pool. This system, however, requires longer planning. First of all, it is necessary for the first user to enter his or her data into the system in order for the second user to find this data and to react to the offer, and finally, for the offering user to accept the offer. Such a system can therefore be used only for regular travel or, at most, in the event of preparation in the longer term.

Furthermore, such a search is usually started from a home computer with Internet capability. As a result, the user, in each instance, must first of all decide that he or she wants to form a car pool, and then must plan his or her trip, i.e. manage his or her travel using the home computer. Particularly in the case of smaller trips, the user might already lose interest after a small number of attempts, and therefore use the system that is actually available only in very inefficient manner.

### SUMMARY OF THE INVENTION

Against this background, it is an object of the present invention to provide a method for supporting the formation of car pools, which explicitly simplifies very short-term formation of car pools and uses the existing systems for initiating car pools more efficiently.

These and other objects are achieved, according to the invention, by a method for supporting the formation of car pools in which a user terminal is data-connected with a server that comprises a database, and the database contains a user data set assigned to the user terminal. The server searches for correlating second user data sets within the database upon a query by the user terminal, and, in the event of success, transmits a public part of these second user data sets to a user terminal. A navigation device is assigned to the user terminal, and a travel route calculated by the navigation device is transmitted to the server by way of the user terminal as a current or regular travel route and entered into the user data set. The server searched for correlating second user data sets upon a query from the user terminal, which sets having the same current or regular travel routes, at least in sections, and reports the results of this search back to the user terminal.

The navigation device transmits its current coordinates to the server at regular or irregular intervals, whereby the server derives regular travel routes from this transmission and enters the regular travel routes into the user data set that belongs to the user terminal. Other practical embodiments of such a method are discussed below.

Similar to known methods, the method according to the invention uses a central server to communicate with user terminals. Fundamentally, every user possesses a user terminal, as well as a user data set that is contained in the database assigned to the server.

In addition, a navigation device is assigned to the user terminal, which can also be accommodated in a common module, for example. In this connection, navigation device refers to any form of position determination, which can also be coupled with the user terminal directly, in the same module. In particular, a user terminal in the form of a so-called smart phone, to which a navigation software is assigned, is proposed as an embodiment of the user terminal.

The user can now use his or her navigation device in conventional manner, to calculate a travel route that either leads from one selected location to another selected location, or from the current position to a specific destination location. After calculation of the travel route, the navigation device can transmit the calculated travel route to the server, where this route is entered into the user data set, by way of the user terminal.

Subsequently, the server searches the other user data sets stored in the database for correlating data sets, from which it can be expected, according to criteria that can be established, that it would be practical to form a car pool between two users. The most important prerequisite here is surely the same travel route, at least in certain sections, but other characteristics are also possible as search criteria, for example age, gender, smoker/non-smoker, and many more.

The server will report the result of the search back to the user terminal, and transmit a public part of the user data sets found when doing so. Such a public part can contain a user ID, for example, by way of which a second user can be contacted, or also already parts of the aforementioned characteristics.

Although not necessary, the complete data set of the second user may be made accessible to the user only after an agreement concerning formation of a car pool has been reached and the server was informed of this agreement, in order to maintain the anonymity of the users, relative to one another, in case of doubt.

In this manner, it is possible to simultaneously check, when entering a travel route into the navigation system, whether a similar trip might be being planned in the vicinity and at the same time, or, if applicable, a passenger can be picked up on the way. Thus, regular use of the home computer before every trip is not necessary. The possibilities of the system are used clearly more effectively in this way, and furthermore, it is easily possible to involve the system even for individual trips some of which might actually occur spontaneously. By taking along the user terminal, it is furthermore also possible to plan or re-plan a trip while underway, and, for example, to switch from a train to a car pool while underway.

It is possible, within the scope of the invention, not only to build a query into the method, as to whether or not the input travel route is to be transmitted to the server, but also to have this transmission to the server carried out automatically by the user terminal. If it is not desired, for one route segment or another, either to take passengers along in the car, for example because the car will already be full, or also because the user does not wish to travel in the car of a stranger, then in this way, the user, in each instance, can opt out of the system, if applicable also only for certain periods of time.

The same holds true for the information as to whether an input travel route is a regular or current travel route. A regular travel route means, for example, a morning trip to work, whereby the regularity with which this regular trip takes place can also be input, along with regularity as such. For example, it can be provided here that such a regular trip takes place every work day at 8:00 in the morning, or also every second Saturday at 12:00 noon. If this trip is not a regular travel route, in other words one that is repeated, if necessary, the system can be parameterized to the effect that this travel route is merely a current trip. Optionally, it can also be additionally input when this trip is actually supposed to begin. Sometimes it is certainly reasonable to report such a trip slightly ahead of the time of the actual start of travel, so that a possible passenger who is located in the vicinity actually has the opportunity to react to it in timely manner. An inquiry as to whether another user is interested in traveling along can then be carried out before or at the start of travel, for example.

In a further development of the method, the system can determine such regularity even without input of a regular travel route, in that the navigation device sends its current coordinates to the server at regular or irregular intervals. The server then determines the currently traveled route from the coordinates visited, one after the other, and compares it with earlier trips located in the memory, so that the system either enters such trips, which are recognized as being regular, into the user data set as such, or at least makes a suggestion to the user to file such a travel route as a regular travel route. This expansion is based on the insight that the driver will generally not use a navigation device for routes with which he or she is familiar. A driver does not have to use the navigation device to orient himself or herself on such familiar routes.

The routes determined by the system or also those input manually can advantageously be subdivided, by the system, into travel route segments, in that path points are assigned to the travel routes. In particular, such path points can be set at larger node points, for example rest stops or larger cities, which means simplification with regard to picking up passengers solely for partial routes. By means of the explicit introduction of path points, it is specifically made possible for these path points to also be compared with starting points and destination points of other path routes, and that the search for common travel routes or travel route segments is simplified. If, for example, a first user is driving from Augsburg to Karlsruhe, it would be possible, by introducing the path points Ulm and Stuttgart, to also transport a second user, with Ulm as a location and Stuttgart as a travel destination, on this path. For this purpose, it can be practical to treat such start points and destination points as well as the path points with a certain tolerance. In this way, driving past a city on a major traffic artery, at a certain distance from the city, nevertheless will be considered tangent to the path point of this city. This tolerance is due to the recognition that it is rather rare to find a route that agrees 100%, and that when driving past a location that is at a slight distance off the route, a slight detour is certainly acceptable, in order to pick up a passenger.

Such start points and destination points, as well as the path points, can advantageously be set on the server directly by way of an Internet portal, so that there, clearly understandable management of the regular travel routes, if necessary also of the current travel routes, can take place. Also, a query concerning correlating user data sets can also easily take place by way of this Internet portal.

Fundamentally, in the method described, it is possible to differentiate between an offer and a request, whereby the nature of an offer, the nature of a request, or both can be assigned to a user data set with a certain travel route. In this connection, an offer means that use of the user's vehicle is planned, whereas a request explicitly provides for use of someone else's vehicle. If a travel route is characterized as an offer and a request, then it is possible to negotiate about the use of the vehicle, in each instance. It makes sense to combine travel routes that are characterized as a request only with travel routes of other user data sets that are declared to be an offer, so as to make sure that a vehicle is present on at least one side. If necessary, the method can also be modified to the effect that an offer can also be combined with an offer of another user. In this case, the users can come to terms concerning use of one of the two vehicles.

After the server has signaled to the inquiring user and, if applicable, also to the user that was found, that the possibility of forming a car pool was found, it will prompt at least one of the users in question to issue an offer for initiating a car pool. Within the scope of such an offer, the user is given access, by way of his or her user terminal, to at least the public part, and if applicable also the non-public part of the user data set of the other users involved. At the same time, the users can clarify the modalities of riding together as part of a car pool with one another. In a specific embodiment, it is possible, for example, to enter an amount of money that represents the share of the travel costs to be paid. Subsequently, this share can later be negotiated by the users, if necessary.

Because communication between server and user terminal is usually handled, as has already been mentioned, by way of a wireless communication connection, for example radio, mobile Internet or Global Positioning System-Short Message Service (GPS-SMS), it is also possible that the server initiates direct communication between the user terminals. Such direct communication can be kept anonymous when it is brought about. In this way, if the negotiations do not succeed, data abuse is avoided. Such a communication connection can also be a voice connection, which is particularly established between the user terminals after confirmation by at least one of the two users. Preferably, Voice-over-Internet Protocol (VoIP) is used for such a voice connection, but other suitable voice connections are also possible for this connection. Other direct communication connections, such as a chat line, for example, can also be used according to the invention.

Supplemental to the method described above, it is also possible to call a second user, using the ID assigned to him or her, and to check whether a car pool with a specific user can be formed. For this purpose, the user can use the motor vehicle license plate as an ID, for example, whereby then, an ID in some form should be assigned to the motor vehicle license plate on the vehicle, to make it clear that the driver of the vehicle in question is a user of the service described. This assignment can be done, for example, by means of a sticker or a distinctive color of the license plate holder. In the case of such a query based on an ID, the server will specifically call up the user data set that is connected with the ID. Afterwards, the server will check if there might be specific agreement between the travel routes, and submit a corresponding offer. Furthermore, automatic recognition can also take place as to whether the registered user has filed his or her motor vehicle license plate with the service, in the user data.

As an alternative to absolute addressing of the second user being approached, relative addressing can also take place in that the second user is identified by way of his or her current position. For this purpose, a distance measurement between the user and the second user can be carried out, for example by way of a radar device on the vehicle of the user. Depending on the geographic position and orientation of the radar, a conclusion concerning the position of the second user can be drawn from this distance measurement and identification can be undertaken in this way.

A requirement for this service is a navigation system or a route planner that is connected with the user terminal.

In specific terms, in the event contact is made, a GPS-SMS message can be directed at the second user. This message triggers a conversation with the user, for example on the user terminal of the second user, in other words establishes a communication connection with the user terminal of the user.

It is practical in this case, but also for other applications, if the geographic position of the users is recorded at regular or irregular time intervals and passed on to the server, so that identification of the participating users on the basis of their position is possible. Furthermore, it is thereby possible to pass on the position of one or more second users to users authorized for this purpose, so that this position can be made visible to the authorized users.

In specific terms, in this way a user can put a second user on a positive list, at least after he or she agrees, whereby the position data of the second users entered into this positive list are displayed on a grid map stored in the user terminal of the user. In this way, the user can follow the movements of the second user and thus decide whether and where a meeting with the second user can or should take place.

The grid map, which is advantageously used also to calculate the route, must be the same on all the user terminals involved, in this connection. In this way, coordination of the grid maps takes place when including a user in the positive list. Deviations in the user positions can thereby be avoided. Preferably, recourse to a common data source can also be preset, so that a grid map is kept available on the server, for example, which is used by all the users.

A communication connection can be established by way of the grid map on which the position of a second user is also shown, in that a GPS-SMS message is sent to the second user, triggering a call back, as was already described above. In this connection, calculation of the position of the second user can be eliminated, because the position of the second user is known to the system.

In this regard, as an alternative to making contact by way of the GPS-SMS message, a call to the second user can also initiated, because his or her user data are known to the user.

Finally, the position data that are already available in the system can be used to send the user position-relevant contents. For example, this data can be advertising that relates to specific offers in the surroundings of the user. Likewise, for example when entering a theater, the program can be made available to the user in this way.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a communication schematic of a method for supporting the formation of car pools,

FIG. 2 is a grid map with multiple users whose position data are exchanged by way of a positive list, and

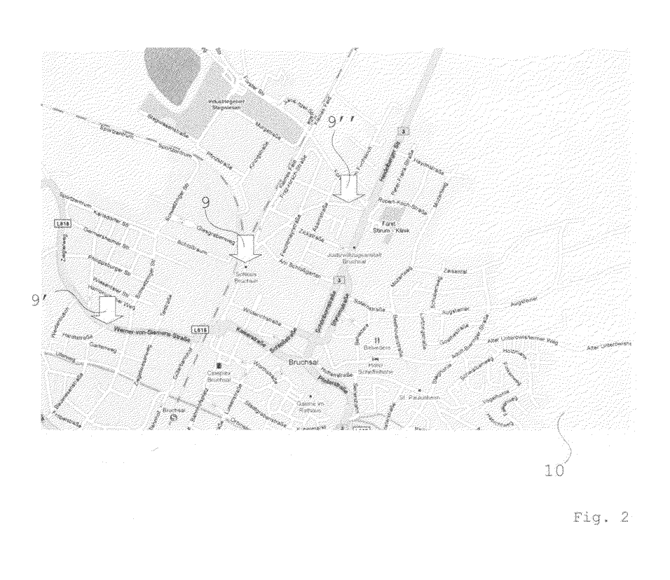

FIG. 3 is a communication schematic of a method for making contact with a second user.

### DETAILED DESCRIPTION OF PREFERRED EMBODIMENTS

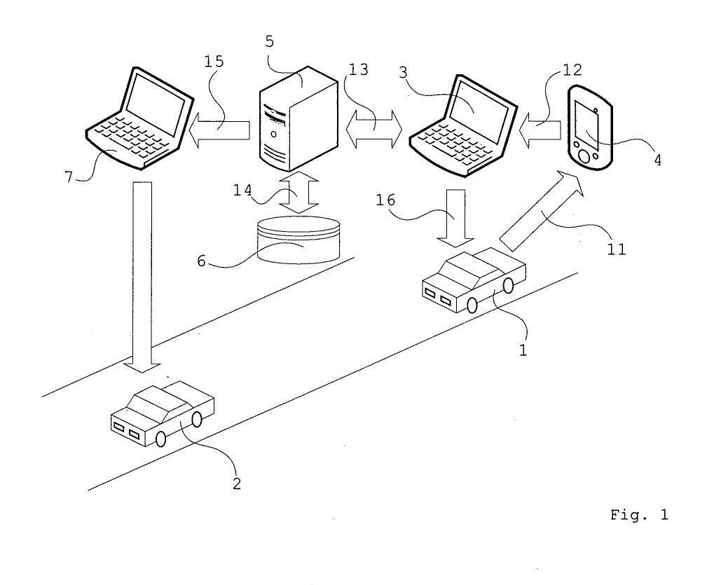

Referring now in detail to the drawings, FIG. 1 shows a communication schematic, in which a user 1 is taking a trip with his motor vehicle. At the start of the trip, user 1 will use his or her navigation device 4 equipped with a GPS system to undertake a travel route input 11, in order to thereby have the navigation device 4 calculate the way to his or her destination. After the travel route has been calculated for user 1, navigation device 4 will have the travel route data 12 transferred or passed on to a user terminal 3 of user 1, whereupon user terminal 3 passes the travel route data on to a server 5, by way of communication 13 with it. Server 5 has a database 6 assigned to it, in which user data sets are stored, including a data set for user 1. Server 5 will store the travel route data received from user terminal 3 in the user data set of user 1, and then starts a search in database 6, in order to find correlating data sets.

Another user 2, who is also included in the system, is traveling on the same road as user 1. This user has already input his or her travel route data into database 6, beforehand, by way of a second user terminal 7. After the travel route input 11 has been entered by user 1, server 5 now reconciles the data sets with one another in database 6, and determines, by way of a database query 14, that users 1 and 2 have planned a travel route that is at least partly the same. Server 5 will therefore draw up an offer 15 to user 2, in which it gives user 2 the opportunity to decide whether he or she wants to form a car pool with user 1. Server 5 will do the same with user 1. User 2 can now make an offer to user 1, by way of his or her second user terminal 7, concerning the amount for which he or she would continue the common partial route with user 1. The amount in question serves for proportional coverage of the common travel costs, in this connection. A message 16 about this amount is then sent to user 1, who can thereupon decide whether or not he or she wants to continue the trip together with user 2, under the stated conditions. At this stage, other components of the user data set can also be taken into consideration, for example whether user 2 is a smoker or non-smoker, as well as other personal and other possibly decision-relevant data.

If multiple users 1, 2 use the method described above jointly, then regular determination of the position of the individual users 1, 2 can take place, so that regularly updated data concerning the position of users 1, 2 are available in database 6. Thus, a user 1 can include a second user 2 in a positive list, which contains position data of second user 2 after authorization from second user 2. All the position data contained in the positive list of user 1 are entered as position markers 9, 9′, 9″ on a grid map 10 stored in user terminal 3 of user 1. The movement of the individual position markers 9, 9′, 9″ on grid map 10 represent the changing positions of users 1, 2.

User 1, whose position is identified with the position marker 9, therefore recognizes, by glancing at grid map 10 of his or her user terminal 3, that two users 2 with the position markers 9′, 9″ are in his or her vicinity. If he or she decides to meet with second user 2, whose position is represented by the position marker 9′, he or she can continue to follow both his or her own route and the route of user 2 on grid map 10. In particular, this procedure is helpful for explaining a route to user 2, for example.

If user 1 wishes to speak with user 2 directly, he or she simply clicks on the position marker 9′ of user 2. User terminal 3 asks database 6 of server 5 for the required user data, for which authorization of user 2 is available. With the data of the user data set, which comprise a telephone number, user terminal 3 establishes a communication connection with user terminal 7 of second user 2.

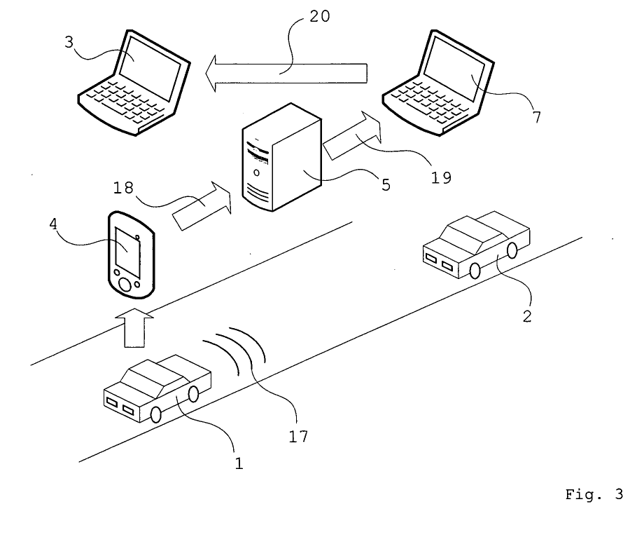

FIG. 3 finally shows another possibility of establishing communication using the method according to the invention. A user 1 and a user 2 are traveling along a road, whereby user 1 would like to make contact with user 2. User 1 undertakes a distance measurement 17 from the vehicle of user 2 by means of a radar device and calculates the geographic position of user 2 on the basis of the distance measurement 17 and his or her own position, as well as the orientation of the radar device. By way of server 5, which finds user 2 by means of a query 18 supported by the navigation data of navigation device 4, based on his or her indicated position, a GPS-SMS message 19 is sent to user terminal 7 of user 2, triggering a call 20 to user terminal 3 of user 1 in user terminal 7.

Thus, a method has been described above to support the formation of car pools, in which an offer for forming a car pool for a specific travel route is provided, directly along with input of the travel route in question into the vehicle navigation system. This method simplifies and facilitates the use of such a system and makes a significant contribution to its efficiency.

Although only at least one embodiment of the present invention has been shown and described, it is to be understood that many changes and modifications may be made thereunto without departing from the spirit and scope of the claims.

What is claimed is:

1. A method for supporting formation of a car pool comprising:
(a) data-connecting a plurality of user terminals with a server comprising a database, the database containing a plurality of user data sets, each user data set being associated with a respective user terminal, each use terminal being associated with a respective navigation device, each navigation device transmitting current coordinates of the navigation device to the server at regular or irregular intervals, the server deriving travel routes from the current coordinates transmitted and entering the travel routes into the data set associated with the user terminal associated with the navigation device;
(b) calculating a first travel route by a first navigation device associated with a first user terminal of the plurality of user terminals;
(c) entering the first travel route into a first user data set of the plurality of user data sets; and
(d) causing the server to search for correlating user data sets within the database having travel routes comprising sections identical to sections of the first travel route upon receiving a query from the first user terminal and, upon successfully locating a correlating user data set, to transmit a public part of the correlating user data set to the first user terminal.

2. The method according to claim 1, wherein the first travel route calculated by the navigation device is automatically passed on to the server after calculation of the first travel route.

3. The method according to claim 1, wherein at least one of the user terminal and the navigation device is parameterized as to whether the first travel route is a regular travel route or a current travel route and if a regular travel route according to what rules the first travel route repeats.

4. The method according to claim 3, wherein the travel route is subdivided into travel route segments using specified path points or path points determined automatically by the server from travel route data created by the navigation device.

5. The method according to claim 1, further comprising an Internet portal assigned to the server for a user associated with a user terminal of the plurality of user terminals to enter a current or regular travel route into the user data set associated with the user terminal to direct queries concerning correlating user data sets to the server.

6. The method according to claim 1, wherein start coordinates, destination coordinates, and path point coordinates for travel routes, are introduced within each of the user data sets, the coordinates of two of the user data sets being compared within a predetermined tolerance to determine current or regular travel routes shared by the two user data sets.

7. The method according to claim 1, further comprising formulating current or regular travel routes within a respective user data set, as offers or as requests, whereby the server, in the search for correlating user data sets, connects offers with only at least one request, in each instance.

8. The method according to claim 1, wherein the server, after transmission of a search result with at least one hit, prompts at least one user selected from the group consisting of a querying user associated with the first user terminal or a located user associated with a correlating user data set located in the search to issue an offer for initiating a car pool.

9. The method according to claim 8, wherein the offer for initiating a car pool is transmitted by the server to the located user by way of the user terminal associated with the located user and wherein if the offer is accepted by the located user, a non-public part of the user data set associated with the user terminal is made accessible to the querying user and any other user associated with a correlating user set located in the search.

10. The method according to claim 8, wherein the communication between the server and the user terminals is handled by way of radio, mobile Internet or Global Positioning System-Short Message Service (GPS-SMS).

11. The method according to claim 9, wherein the server, in the event of a successful search, prepares a direct communication connection between at least the first user terminal and the user terminal associated with the located user and simultaneously transmits a search result of the successful search, the connection being established after confirmation by the at least one user.

12. The method according to claim 11, wherein the communication connection is a chat line or a voice connection.

13. The method according to claim 11, wherein the communication connection is a voice connection using Voice-over-Internet protocol (VoIP).

14. The method according to claim 1, wherein a first user associated with the first user terminal of the plurality of user terminals can direct the query to the server, by entering a user ID of a second user associated with a second user terminal of the plurality of user terminals into the first user terminal, for reconciliation of the first user data set assigned to the first user terminal with a second user data set assigned to the user ID of the second user.

15. The method according to claim 14, wherein the user ID is an alias name or a motor vehicle license plate number.

16. The method according to claim 14, wherein the user ID is a current position of the second user determined from a position of the first user and a distance from the second user, determined by way of a distance measurement.

17. The method according to claim 16, wherein the first user enters into contact with the second user by sending a Global Positioning System-Short Message Service (GPS-SMS) message to the second user terminal.

18. The method according to claim 1, wherein the first user enters into contact with a selected number of second users respectively associated with user terminals of the plurality of user terminals by sending a Global Positioning System-Short Message Service (GPS-SMS) message to all the second users in a territory defined on a grid map.

19. The method according to claim 1, wherein the first user terminal determines a position of the first user terminal using the navigation device associated with the first user terminal at regular or irregular time intervals, and enters a respective current position into the database as position data.

20. The method according to claim 19, wherein position data from the user data sets of other user terminals are read out by way of the first user terminal, from the database, and positions of the other user terminals together with the position of the first user terminal, is displayed on a grid map of the surroundings.

21. The method according to claim 20, wherein the position data of the users are stored in memory and transmitted as grid coordinates.

22. The method according to claim 20, wherein navigation is carried out using the grid map.

23. The method according to claim 20, wherein the grid map that is used as a map of the surroundings and a navigation grid map on which navigation is based are either reconciled with one another between the first user terminal and the other user terminals or obtained from a common data source.

24. The method according to claim 19, wherein communication with a second user is established by clicking on a position display of the second user so that a Global Positioning System-Short Message Service (GPS-SMS) message is sent to the second user activating a second user terminal associated with the second user and triggering establishment of a communication connection.

25. The method according to claim 19, wherein position-relevant contents of the database are sent to the first user terminal as a function of position of the first user terminal by a Global Positioning System-Short Message Service (GPS-SMS) message.
